(19) United States
(12) Patent Application Publication
(10) Pub. No.: US 2026/0329132 A1
(43) Pub. Date: Oct. 22, 2026

(54) Display Device for a Motor Vehicle and Associated Motor Vehicle

(71) Applicant: Bayerische Motoren Werke Aktiengesellschaft, Muenchen (DE)

(72) Inventor: Sebastian Takeshi LAMPEN, Minato City, Tokyo (JP)

(21) Appl. No.: 19/484,025

(22) PCT Filed: May 2, 2024
(86) PCT No.: PCT/DE2024/100402

§ 371 Date: Nov. 13, 2025

(30) Foreign Application Priority Data
Jun. 2, 2023 (DE) 10 2023 114 511.8

(51) Int. Cl. G02F 1/1335; G02B 27/01

(52) U.S. Cl. CPC G02F 1/133607; G02B 27/0101

(57) ABSTRACT

A display device for a motor vehicle has a display surface and a light element which has a surface that corresponds to the display surface and is oriented towards the display surface and is designed to emit light which can be provided by the light element. A first diffuser element is arranged between the surface of the light element and the display surface and is designed to homogenize the light of the light element, A second diffuser element is also arranged between the surface of the light element and the display surface. The second diffuser element acts as a diffuser for light incident at a shallow angle from the light element and is transparent for light from the light element incident on it at a steep angle.

### BACKGROUND AND SUMMARY

The invention relates to a display device for a motor vehicle. Further, the invention relates to a motor vehicle with such a display device.

In motor vehicles, such as passenger vehicles, vans, or trucks, a display device is often provided, in particular in the dashboard, which can display the speed of the motor vehicle, for example.

KR 10-1233890 B1 discloses a liquid crystal display having laminated diffuser plates.

To be able to operate a motor vehicle particularly efficiently, it is desirable for components used in the motor vehicle, such as the display device, to be able to be operated particularly efficiently.

It is therefore the object of the present invention to provide a display device and a motor vehicle, for which particularly efficient operation can be enabled.

This object is achieved by the subjects of the independent claims. Advantageous embodiments and refinements of the invention are specified in the dependent claims, the description, and the drawings.

A first aspect of the invention relates to a display device for a motor vehicle. The display device for a motor vehicle according to the invention comprises a display surface and a light element, which has a surface corresponding to the display surface and this surface is oriented toward the display surface and is designed to emit light that can be provided by the light element. The display device includes a first diffuser element arranged between the surface of the light element and the display surface, which is designed to homogenize the light of the light element, in particular to uniformly illuminate the display surface, and a second diffuser element, likewise arranged between the surface of the light element and the display surface, which acts as a diffuser for light incident from the light source at a flat angle and which is substantially transparent to light from the light source incident at a steep angle.

The display surface can comprise, for example, a liquid crystal display and can therefore be made transparent depending on the switching of the liquid crystals, so that the light element is used to illuminate the display surface and therefore be able to operate the display device analogously to a classic TFT monitor. The first diffuser element can be, for example, a type of frosted glass, which is used to homogenize the light of the light element. The light element can thus be formed, for example, from individual fluorescent tubes arranged adjacent to one another or individual LED elements, which are to effectuate the most uniform possible illumination of the display surface. For this purpose, in particular the surface of the light element is essentially equal in size to the display surface. Essentially in this case means that a size difference of a few percent can be possible. The display surface together with the light element and the first diffuser element therefore essentially forms a classic arrangement for a display device.

The second diffuser element is then used to be able to operate the display device particularly efficiently and is designed so that, for light which is emitted from the surface of the light element and is incident on the second diffuser element, which in particular likewise includes a surface, at an angle which is essentially perpendicular to the surface of the second diffuser element, the second diffuser element does not operate as a diffuser, but rather is at least essentially transparent. The possible transmission for light of the second diffuser element incident essentially at a right angle on the surface is therefore particularly high and causes no or only particularly little diffusion of the light incident at these angles. The size of the surface of the second diffuser element can essentially correspond to the size of the display surface or the size of the surface of the light element.

As angles at which the light or light beams are incident on the surface of the second diffuser element become increasingly flatter, its property as a diffuser increases. That is to say, light beams emerging obliquely from the light element can likewise be deflected at the second diffuser element analogously to the first diffuser element such that they propagate according to a spherical wave in more or less all directions. The effect thus results that light which leaves the light element or its surface obliquely and would therefore emerge, even before the display surface, laterally from the display device or the area between surface of the light element and display surface, is at least partially returned into the second diffuser element due to the diffusion taking place there. This light returned due to the diffusion is therefore not lost for the illumination of the display surface or less light intensity of the light element is lost overall in this way. The second diffuser element can in particular be formed from plastic, which has the required properties with respect to the light refraction.

In other words, a display device is provided in which light can still be used effectively in spite of, for example, a broad emission characteristic of LEDs and/or optical units which provide the light of the light element at the surface, the second diffuser element is helpful, which is transparent for flat angles but is diffuse for steeper angles and can ensure better homogeneity there, due to which the display surface can be illuminated particularly uniformly, for example. The light element is used as the backlight for the display surface.

A backlight can be used in liquid crystal displays and display screens. It is attached behind the display surface or the liquid crystal display in order to operate an information display in transmitted light. Depending on the actuation of image segments on or in the display surface, the light is absorbed at different levels therein, which creates the impression of a self-luminous image when it is observed.

The second diffuser element is advantageously arranged between the first diffuser element and the light element. In other words, in a classic arrangement of the light element, the first diffuser element, and the display surface, the second diffuser element is attached in the beam path in front of the first diffuser element, so that light beams emerging at a flat angle at the edges of the surface, which is determined on the outer circumference side by the size of the display surface, can be returned to the first diffuser element in order to enable particularly advantageous homogeneity. The advantage thus results that the display device can be illuminated particularly uniformly.

In a further advantageous design of the invention, the display surface comprises a liquid crystal display. In other words, the display device is designed as a liquid crystal display screen, in which, the display surface influences the light for display purposes by a polarization direction of the liquid crystals specifiable by means of an electric voltage. The advantage thus results that the display device can especially be formed using components which are already especially tested, by which reliability can be increased, for example.

In a further advantageous design of the invention, the light element includes multiple emitters, in particular light-emitting diodes (LEDs), organic light emitting diodes (OLEDs), and/or quantum dots, by which the light can be provided. In other words, multiple light-emitting elements, which are arranged, for example, in the form of a matrix or in rows and columns, in particular flatly, and which form the surface of the light element and provide the light are provided. A quantum dot is a nanoscopic material structure, in particular made of a semiconductor element, which can advantageously be excited to light emission and is thus advantageously suitable as a backlight. The advantage thus results that particularly efficient operation is enabled in a particularly efficient manner, for example in particular in comparison to laterally illuminated display surfaces.

In order to enable a particularly advantageous yield of light and therefore particularly efficient operation in a light element designed in such a manner, it is advantageous if the second diffuser element includes individual segments corresponding to the multiple emitters. An individual diffuser element can thus be provided, for example, for each of the emitters, by which in addition a particularly advantageous design of the display device is enabled.

To now achieve a particularly high light yield by means of the segmented diffuser element, it is provided that the respective segment includes a receptacle or is completely transparent, in particular at a position corresponding to the respective emitter. The second diffuser element can thus be conceived, for example, as a perforated plate, wherein the second diffuser element is arranged so that in each case a hole or a receptacle is arranged directly above an emitter. The second diffuser element can thus advantageously be designed so that it is particularly transparent for light incident at steep angles. The advantage thus results that the display device can be operated particularly efficiently.

In a further advantageous design of the invention, an optical element, in particular a collimator and/or a field lens, is assigned to the respective emitter. In other words, to improve the emission characteristic of the respective individual emitter and, for example, to advantageously suppress at the beginning of the beam path scattered light obliquely emerging from the outset, an optical element is provided which is designed, for example, as a collimator or comprises a field lens which likewise has a collimating effect. The advantage thus results that light can be conducted particularly efficiently from the light element onto the display surface.

In one advantageous design of the invention, the display device forms a component of a head-up display for the motor vehicle. In other words, the display device is used to implement a head-up display for the motor vehicle in that the display device is used as an image generator for irradiating the projection surface, in particular the windshield, of the head-up display. The advantage thus results that a particularly efficient head-up display or head-up display device can be implemented due to a particularly high light yield.

In a further advantageous design of the invention, at least one material of the second diffuser element is a plastic, in particular a drawn plastic. The advantage results due to the use of the plastic that the second diffuser element can be made particularly cost-effectively and additionally has the optical properties required of it.

A second aspect of the invention relates to a motor vehicle which comprises a display device according to the first aspect of the invention.

Advantageous designs and refinements as well as advantages of the first aspect of the invention are to be considered advantageous designs and refinements as well as advantages of the second aspect of the invention and vice versa.

Further features of the invention result from the claims, the figures, and the description of the figures. The features and combinations of features mentioned above in the description and the features and combinations of features mentioned hereinafter in the description of the figures and/or solely shown in the figures are usable not only in the respective specified combination, but rather also in other combinations or alone.

The invention will now be explained in more detail on the basis of a preferred examplary embodiment and with reference to the drawings.

### BRIEF DESCRIPTION OF THE DRAWINGS

FIG. 1 is a schematic sectional view of a display device for a motor vehicle having a display surface; and

FIG. 2 is a schematic graphical diagram of an intensity of a light over the display surface.

### DETAILED DESCRIPTION OF THE DRAWINGS

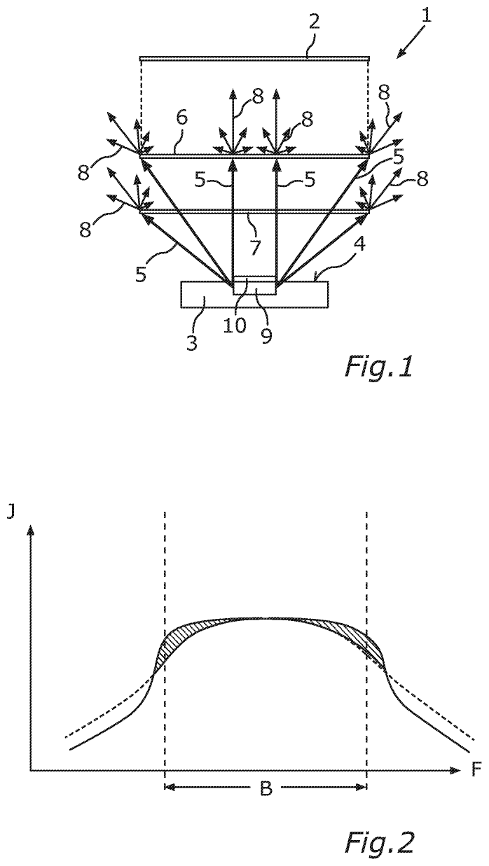

FIG. 1 shows a schematic sectional side view of a display device 1 for a motor vehicle, which can be designed in particular as a passenger vehicle or truck, having a display surface 2 and a light element 3, which has a surface 4 corresponding to the display surface 2 and this surface 4 is oriented toward the display surface 2 and is designed to emit light that can be provided by the light element 3, represented by the beams 5. A first diffuser element 6 is arranged between the surface 4 of the light element 3 and the display surface 2, which is designed to homogenize the light of the light element 3. Therefore, if beams 5 are incident at arbitrary angles on the first diffuser element 6, the diffusion, which is indicated by the further beams 8, then takes place at the respective point of incidence. In FIG. 1, the length of the respective beam 8 in the respective bundle of the beams 8 which are generated from a single beam 5 characterizes the intensity of the light or light beam 8 in the respective direction. The length therefore corresponds to the intensity.

In order that the display device 1 can be used particularly advantageously in the motor vehicle, it is desirable for it to be able to be operated particularly efficiently, for example. In order to achieve this, a second diffuser element 7 is provided, which is likewise arranged between the surface 4 of the light element 3 and the display surface 2 and which acts as a diffuser for light or beams 5 incident at a flat angle from the light source—the light element 3—and which is transparent to light from the light source incident at a steep angle thereon. The property of the second diffuser element 7 is made clear by the beams 8, which only occur there with the two outer beams 5.

For a particularly efficient operation and for an advantageous diffusion of the laterally emerging beams 5, it is advantageous in particular if the second diffuser element 7 is arranged between the first diffuser element 6 and the light element 3.

The light element 3 comprises or includes multiple emitters 9, which can each be formed in particular from a light-emitting diode, an organic light-emitting diode, and/or a quantum dot. For the sake of clarity, only one of the emitters 9 is presented as an example in FIG. 1 for the light element 3.

The display surface 2 is designed, for example, in particular as a liquid crystal display or the display surface 2 comprises a liquid crystal display.

The second diffuser element 7 can be formed from multiple individual segments corresponding to the emitters. Thus, for example, the area or section of the second diffuser element 7 shown in FIG. 1 can form the segment for the corresponding emitters 9, wherein advantageously the respective segment includes a recess or is completely transparent, for example, wherein this is advantageous in particular in the middle area of the respective segment, which can be bounded, for example, in FIG. 1 by the two beams 5 incident perpendicularly on the second diffuser element 7.

For more efficient operation, it is advantageous if an optical element 10, for example in the form of a collimator and/or a field lens, is assigned to the respective emitter 9.

The second diffuser element 7 is in particular formed from a plastic which receives its optical properties, for example due to drawing during the production, which distinguish it in its behavior of the angle-dependent diffusion from the conventional diffuser element 6. This is apparent in FIG. 1 in particular due to the occurrence or presence of the beams 8.

Furthermore, a motor vehicle is to be presented here which comprises the display device 1 and can therefore be viewed schematically on the basis of its display device 1 as shown in FIG. 1.

FIG. 2 shows a schematic diagram of the light intensity over the display surface 2 or its width diagonal to the plane of the drawing. The solid curve or lines represent the intensity distribution I of the display device 1 shown in FIG. 1 over the surface 4 or correspond thereto. The area B corresponds to the width of the display surface 2 according to the orientation shown in FIG. 1.

The dashed curve or line represents an intensity distribution I of a classic display device, which is constructed analogously to the display device 1, but omits the second diffuser element 7. It is apparent on the basis of the diagram of FIG. 2 that especially at the edges of the display surface 2 or the area of the display surface 2, a particularly high light yield is enabled in comparison to the classic display device, which can be achieved by skilled utilization of the properties of the second diffuser element 7. The gain in intensity which is achieved by the presented display device 1 is highlighted by the shaded areas between the two curves.

Particularly efficient operation of the motor vehicle is possible by way of the presented display device 1 and the presented motor vehicle.

### LIST OF REFERENCE SIGNS

1 display device
2 display surface
3 light element
4 surface
5 beams
6 first diffuser element
7 second diffuser element
8 further beams
9 emitter
10 optical element

1.-10. (canceled)

11. A display device for a motor vehicle, comprising:
a display surface;
a light element having a surface corresponding to the display surface and oriented toward the display surface, the surface being designed to emit light provided by the light element;
a first diffuser element arranged between the surface of the light element and the display surface, and designed to homogenize light of the light element; and
a second diffuser element arranged between the surface of the light element and the display surface, the second diffuser element being a diffuser for light incident at a flat angle from the light element and being transparent to light from the light element incident at a steep angle.

12. The display device according to claim 11, wherein
the second diffuser element is arranged between the first diffuser element and the light element.

13. The display device according to claim 11, wherein
the display surface comprises a liquid crystal display.

14. The display device according to claim 11, wherein,
the light element comprises multiple emitters, by which the light is provided.

15. The display device according to claim 14, wherein
the second diffuser element includes individual segments corresponding to the multiple emitters.

16. The display device according to claim 15, wherein
a respective individual segment includes a recess or is completely transparent.

17. The display device according to claim 14, further comprising:
an optical element assigned to a respective emitter.

18. The display device according to claim 17, wherein
the optical element is a collimator and/or a field lens.

19. The display device according to claim 11, wherein
the display device is a component of a head-up display for the motor vehicle.

20. The device according to claim 11, wherein
at least one material of the second diffuser element is a plastic.

21. The device according to claim 20, wherein the plastic is a drawn plastic.

22. A motor vehicle comprising a display device according to claim 11.
